(19) United States
(12) Patent Application Publication
(10) Pub. No.: US 2025/0309706 A1
(43) Pub. Date: Oct. 2, 2025

(54) ELECTRIC APPARATUS

(71) Applicant: HONDA MOTOR CO., LTD., Tokyo (JP)

(72) Inventors: Yoshihisa Kubota, Wako-shi (JP); Kiyoshi Asami, Wako-shi (JP)

(21) Appl. No.: 19/037,361

(22) Filed: Jan. 27, 2025

(30) Foreign Application Priority Data
Mar. 26, 2024 (JP) 2024-048863

(51) Int. Cl. H02K 1/16; H02K 3/48; H02K 11/33

(52) U.S. Cl. CPC H02K 1/16; H02K 3/48; H02K 11/33

(57) ABSTRACT

An electric apparatus includes a rotary electric machine, an electric power control unit, and an AC electric power source connection portion. The rotary electric machine includes a β-phase first coil and a β-phase second coil. The electric power control unit includes: third and fourth full-bridge circuits each being connected to each of both ends of each β-phase coil; and third and fourth connection-disconnection devices each being connected between one end of each β-phase coil and each full-bridge circuit. The AC electric power source connection portion is connected to both ends of each of the third connection-disconnection device and the fourth connection-disconnection device. The electric power control unit connects the β-phase coils in series when electric power of an external AC electric power source is less than predetermined electric power. The electric power control unit connects the β-phase coils in parallel when the electric power of the external AC electric power source is equal to or more than the predetermined electric power.

### CROSS-REFERENCE TO RELATED APPLICATION

Priority is claimed on Japanese Patent Application No. 2024-048863, filed on Mar. 26, 2024, the contents of which are incorporated herein by reference.

### BACKGROUND

### Field of the Invention

The present invention relates to an electric apparatus.

### Background

In recent years, in order to ensure that more people have access to affordable, reliable, sustainable, and advanced energy, research and development relating to charging and electric power supply in a mobility device on which a secondary battery is mounted, which contributes to energy efficiency, has been conducted.

In the related art, for example, electric vehicles are known which convert AC electric power supplied from an external electric power source into DC electric power by a combination of a stator winding of a plurality of phases of a motor and a bridge circuit of a plurality of phases by a switching element (for example, refer to Japanese Unexamined Patent Application, First Publication No. 2012-70613).

### SUMMARY

In the technique relating to charging and electric power supply in a mobility device on which a secondary battery is mounted, it is a problem to improve the efficiency of AC charging by the external electric power source. For example, as in the electric vehicle of the related art described above, when the stator winding of the motor is used as a reactor of a circuit (a power factor correction circuit or the like) that converts AC electric power into DC electric power, there is a possibility that distortion of a current or the like is increased by a relatively small inductance, and the charging efficiency is decreased.

The present application aims at achieving an improvement in the efficiency of AC charging. Further, the present application contributes to energy efficiency.

An electric apparatus (for example, an electric apparatus 10 in the embodiment) according to a first aspect of the present invention includes: an electric power storage device (for example, an electric power storage device 11 in the embodiment); a rotary electric machine (for example, a rotary electric machine 16 (M) in the embodiment) that includes a first coil (for example, a β-phase first coil 33 (β1) in the embodiment) and a second coil (for example, a β-phase second coil 34 (β2) in the embodiment); an electric power control unit (for example, an electric power control unit 10a in the embodiment) that is connected to the electric power storage device and the rotary electric machine and controls electric power transfer of each of the electric power storage device and the rotary electric machine; and an electric power source connection member (for example, an AC electric power source connection portion 15 in the embodiment) that connects the electric power control unit to an external electric power source (for example, an external AC electric power source in the embodiment), wherein the electric power control unit includes: a first full-bridge circuit (for example, a third full-bridge circuit 13a in the embodiment) that is connected to both ends of the first coil; a second full-bridge circuit (for example, a fourth full-bridge circuit 13b in the embodiment) that is connected to both ends of the second coil; a first connection-disconnection device (for example, a third connection-disconnection device 35 in the embodiment) that is connected between one end of the first coil and the first full-bridge circuit; and a second connection-disconnection device (for example, a fourth connection-disconnection device 36 in the embodiment) that is connected between one end of the second coil and the second full-bridge circuit, the electric power source connection member is connected to both ends of each of the first connection-disconnection device and the second connection-disconnection device, the electric power control unit connects the first coil and the second coil in series when electric power of the external electric power source is less than predetermined electric power (for example, predetermined electric power Pth in the embodiment), and the electric power control unit connects the first coil and the second coil in parallel when the electric power of the external electric power source is equal to or more than the predetermined electric power.

A second aspect is the electric apparatus according to the first aspect described above which may include: a third connection-disconnection device (for example, a fifth connection-disconnection device 39 in the embodiment) that is connected between the electric power source connection member and the first connection-disconnection device or the second connection-disconnection device, wherein the third connection-disconnection device may be set to be in a disconnection state when the electric power of the external electric power source is less than the predetermined electric power, and the third connection-disconnection device may be set to be in a connection state when the electric power of the external electric power source is equal to or more than the predetermined electric power.

A third aspect is the electric apparatus according to the first or second aspect described above, wherein the rotary electric machine may include a stator core (for example, a stator core 42 in the embodiment) on which a slot (for example, a slot 43 in the embodiment) shared by the first coil and the second coil is formed, and when the first coil and the second coil are connected in parallel, the electric power control unit may set a flow direction in the first coil and the second coil of a current supplied from the external electric power source such that magnetic fluxes of the first coil and the second coil that are magnetically coupled cancel each other out.

According to the first aspect described above, in a low output region in which the decrease of the efficiency due to ripple and distortion of the current that flows through each coil or the like is large, by connecting the coils in series, it is possible to increase the inductance and prevent the ripple and distortion of the current or the like. In a high output region in which copper loss and iron loss are increased in accordance with the increase of the current in a state where the coils are connected in series, by connecting the coils in parallel, it is possible to decrease the inductance and reduce the loss.

In the case of the second aspect described above, it is possible to easily switch between the series connection and the parallel connection of the coils by including the third connection-disconnection device, and it is possible to prevent an increase of the number of components. The first coil and the second coil are an open-ended coil connected to each full-bridge circuit, and thereby, it is possible to increase a voltage applied to each coil relative to a charging voltage and increase a charging speed, for example, as compared with the case where the coils are not an open-ended coil or the like.

According to the third aspect described above, by supplying electric power to the first coil and the second coil that are arranged in the same slot such that the magnetic fluxes cancel each other out, it is possible to prevent torque generation of the rotary electric machine, and it is possible to increase a voltage increase ratio by a relatively small leakage inductance.

### BRIEF DESCRIPTION OF THE DRAWINGS

FIG. 1 is a view showing the configuration of an electric apparatus of an embodiment of the present invention.

FIG. 2 is a configuration view of each full-bridge circuit and a rotary electric machine in the electric apparatus of the embodiment of the present invention.

FIG. 3 is a block diagram showing the functional configuration of an electronic control unit at the time of AC charging in the electric apparatus of the embodiment of the present invention.

FIG. 4 is a circuit diagram showing an example of the flow of a current in a series mode at the time of AC charging in the electric apparatus of the embodiment of the present invention.

FIG. 5 is a circuit diagram showing an example of the flow of a current in a parallel mode at the time of AC charging in the electric apparatus of the embodiment of the present invention.

FIG. 6 is a view showing an example of a correspondence relationship between a charging output and the loss of the series mode at the time of AC charging in the electric apparatus of the embodiment of the present invention.

FIG. 7 is a view showing an example of a simulation of the change of a current in each of the series mode and the parallel mode at the time of AC charging in the electric apparatus of the embodiment of the present invention.

FIG. 8 is a configuration view of a rotary electric machine of an electric apparatus in a modification example of the embodiment of the present invention.

### DESCRIPTION OF EMBODIMENTS

Hereinafter, an electric apparatus according to an embodiment of the present invention will be described with reference to the accompanying drawings.

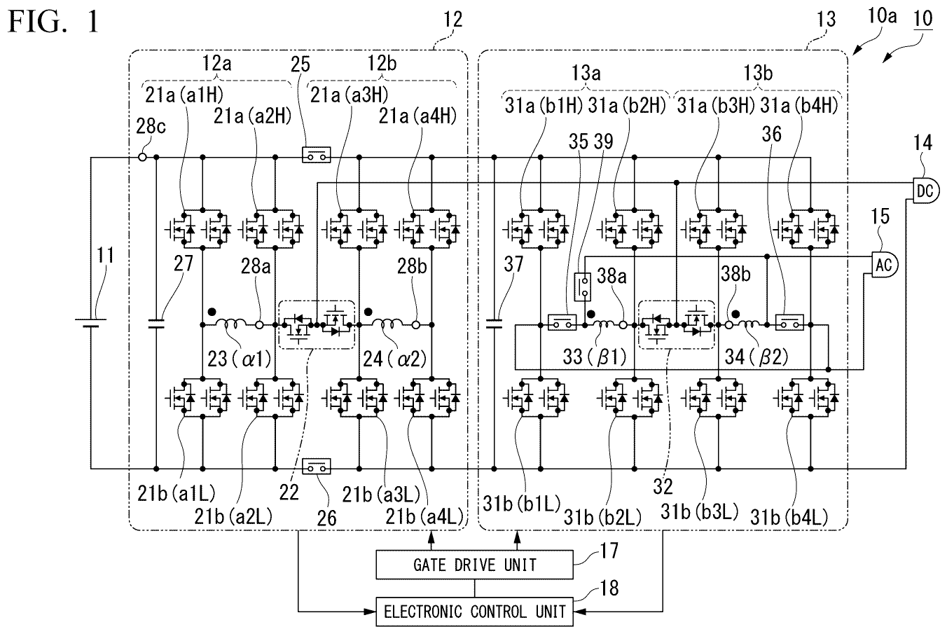

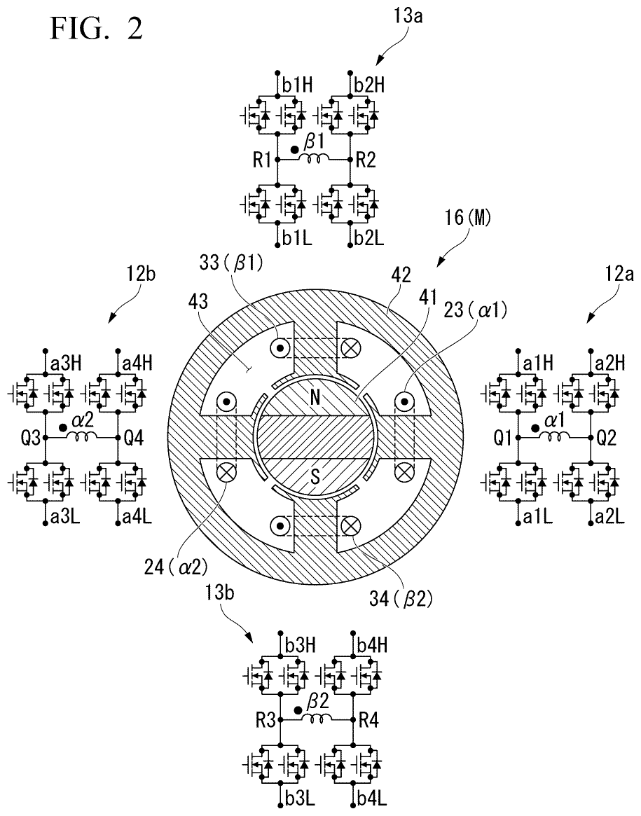

FIG. 1 is a view showing the configuration of an electric apparatus 10 of an embodiment. FIG. 2 is a configuration view of full-bridge circuits 12a, 12b, 13a, 13b and a rotary electric machine 16 in the electric apparatus 10 of the embodiment.

The electric apparatus 10 of the embodiment is mounted, for example, on an electric vehicle, an electric movable body, an electric machine, an electric power source apparatus, and the like. The electric vehicle is, for example, an electric automobile that includes a rotary electric machine as a power source, a saddle riding vehicle, a kick skater, a hybrid vehicle by a combination of a rotary electric machine and an internal combustion engine, a fuel cell vehicle by a combination of an electric power storage device and a fuel cell, and the like. The electric movable body is, for example, a robot, a flying vehicle, a movable body on water, an underwater movable body, and the like. The electric machine is, for example, a construction machinery that includes a rotary electric machine as a power source and the like. The electric power source apparatus is, for example, a stationary or mobile electric power source apparatus that performs discharging and charging of an electric power storage device and the like.

### (Electric Apparatus)

As shown in FIG. 1 and FIG. 2, the electric apparatus 10 of the embodiment includes, for example, an electric power storage device 11, a first electric power conversion portion 12, a second electric power conversion portion 13, a DC electric power source connection portion 14, an AC electric power source connection portion 15 (electric power source connection member), a rotary electric machine 16 (M), a gate drive unit 17, and an electronic control unit 18. For example, the first electric power conversion portion 12, the second electric power conversion portion 13, the DC electric power source connection portion 14, the AC electric power source connection portion 15, the gate drive unit 17, and the electronic control unit 18 constitute an electric power control unit 10a.

The electric power storage device 11 is connected to the first electric power conversion portion 12 and the second electric power conversion portion 13 described later.

The electric power storage device 11 includes, for example, a plurality of battery cells that are connected in series or in parallel. Each battery cell is, for example, a lead storage battery, a lithium-ion battery, a secondary battery such as a nickel hydride battery and an all-solid-state battery, a capacitor such as an electric double layer capacitor, a compound battery by a combination of a secondary battery and a capacitor, or the like. Each battery cell repeatedly performs charging and discharging. The electric power storage device 11 transfers electric power to and from the rotary electric machine 16 via the electric power control unit 10a. The electric power storage device 11 is charged by an external electric power source (an external DC electric power source and an external AC electric power source).

The first electric power conversion portion 12 includes a first full-bridge circuit 12a and a second full-bridge circuit 12b.

Each of the first full-bridge circuit 12a and the second full-bridge circuit 12b includes, for example, a so-called H-bridge circuit formed of a plurality of switching elements connected in two phases by bridge connection. Each switching element is, for example, a transistor of a SiC (Silicon Carbide) or the like, such as a MOSFET (Metal Oxide Semi-conductor Field Effect Transistor) or an IGBT (Insulated Gate Bipolar Transistor). Each switching element is, for example, an N-channel type MOSFET.

The plurality of switching elements are, for example, a pair of transistors forming each of high-side arm and low-side arm element portions 21a, 21b that form a pair in each phase. Each pair of transistors of each element portion 21a, 21b is a pair of transistors connected, for example, in parallel.

Each full-bridge circuit 12a, 12b may include, for example, a rectifier element such as a reflux diode which is connected in parallel between a collector and an emitter of each transistor in a forward direction toward the collector from the emitter.

The first electric power conversion portion 12 includes, for example, a first switch 22 connected between neutral points Q2, Q3 of the first full-bridge circuit 12a and the second full-bridge circuit 12b. The neutral point Q2 of the first full-bridge circuit 12a is, for example, a connection point between a high-side arm element portion 21a (a2H) and a low-side arm element portion 21b (a2L) that are connected in series in a second phase among first and second phases of two phases of the first full-bridge circuit 12a. For example, the neutral point Q2 is a connection point between a source of the high-side arm element portion 21a (a2H) and a drain of the low-side arm element portion 21b (a2L). The neutral point Q3 of the second full-bridge circuit 12b is, for example, a connection point between a high-side arm element portion 21a (a3H) and a low-side arm element portion 21b (a3L) that are connected in series in a first phase among first and second phases of two phases of the second full-bridge circuit 12b. For example, the neutral point Q3 is a connection point between a source of the high-side arm element portion 21a (a3H) and a drain of the low-side arm element portion 21b (a3L).

The first switch 22 is, for example, a bidirectional switch formed of two switching elements. Each switching element is a transistor such as a MOSFET or an IGBT and is, for example, an N-channel type MOSFET. The first switch 22 includes, for example, two transistors connected reversely in series. For example, the sources of the two transistors are connected to each other, and thereby, the two transistors are connected in series in a direction opposite to each other. The first switch 22 switches conduction and cutoff of a current between the neutral points Q2, Q3 by ON (conduction)/OFF (cutoff) of the two transistors.

Each transistor may include a rectifier element such as a reflux diode which is connected in parallel between a collector and an emitter in a forward direction toward the collector from the emitter.

The first electric power conversion portion 12 is connected to an α-phase first coil 23 (α1) and an α-phase second coil 24 (a2) of the rotary electric machine 16 described later. The α-phase first coil 23 is connected between neutral points Q1, Q2 of the first full-bridge circuit 12a. The α-phase second coil 24 (a2) is connected between neutral points Q3, Q4 of the second full-bridge circuit 12b. The neutral point Q1 of the first full-bridge circuit 12a is, for example, a connection point between a high-side arm element portion 21a (a1H) and a low-side arm element portion 21b (a1L) that are connected in series in the first phase of the first full-bridge circuit 12a. For example, the neutral point Q1 is a connection point between a source of the high-side arm element portion 21a (a1H) and a drain of the low-side arm element portion 21b (a1L). The neutral point Q4 of the second full-bridge circuit 12b is, for example, a connection point between a high-side arm element portion 21a (a4H) and a low-side arm element portion 21b (a4L) that are connected in series in the second phase of the second full-bridge circuit 12b. For example, the neutral point Q4 is a connection point between a source of the high-side arm element portion 21a (a4H) and a drain of the low-side arm element portion 21b (a4L).

The first electric power conversion portion 12 includes a first connection-disconnection device 25 connected between positive electrodes of the first full-bridge circuit 12a and the second full-bridge circuit 12b and a second connection-disconnection device 26 connected between negative electrodes of the first full-bridge circuit 12a and the second full-bridge circuit 12b.

Each of the first connection-disconnection device 25 and the second connection-disconnection device 26 is, for example, a contactor and switches between ON (conduction) and OFF (cutoff) of the connection between the first full-bridge circuit 12a and the second full-bridge circuit 12b.

The first electric power conversion portion 12 includes, for example, a capacitor (condenser) 27 connected between the positive electrode and the negative electrode. For example, the capacitor 27 smooths voltage variation generated in accordance with a switching operation between ON (conduction) and OFF (cutoff) of each switching element of the first electric power conversion portion 12.

The first electric power conversion portion 12 includes, for example, a first current sensor 28a arranged between the α-phase first coil 23 (α1) and the neutral point Q2, a second current sensor 28b arranged between the α-phase second coil 24 (α2) and the neutral point Q4, and a third current sensor 28c arranged between the electric power storage device 11 and the first electric power conversion portion 12.

For example, the first current sensor 28a detects a current that flows through the α-phase first coil 23 (α1). The second current sensor 28b detects a current that flows through the α-phase second coil 24 (α2).

The third current sensor 28c detects a current that flows between the first electric power conversion portion 12 and the electric power storage device 11.

The second electric power conversion portion 13 includes a third full-bridge circuit 13a and a fourth full-bridge circuit 13b.

Each of the third full-bridge circuit 13a and the fourth full-bridge circuit 13b includes, for example, a so-called H-bridge circuit formed of a plurality of switching elements connected in two phases by bridge connection. Each switching element is, for example, a transistor of a SiC or the like, such as a MOSFET or an IGBT. Each switching element is, for example, an N-channel type MOSFET.

The plurality of switching elements are, for example, a pair of transistors forming each of high-side arm and low-side arm element portions 31a, 31b that form a pair in each phase. Each pair of transistors of each element portion 31a, 31b are connected, for example, in parallel.

Each full-bridge circuit 13a, 13b may include, for example, a rectifier element such as a reflux diode which is connected in parallel between a collector and an emitter of each transistor in a forward direction toward the collector from the emitter.

The second electric power conversion portion 13 includes, for example, a second switch 32 connected between neutral points R2, R3 of the third full-bridge circuit 13a and the fourth full-bridge circuit 13b. The neutral point R2 of the third full-bridge circuit 13a is, for example, a connection point between a high-side arm element portion 31a (b2H) and a low-side arm element portion 31b (b2L) that are connected in series in a second phase among first and second phases of two phases of the third full-bridge circuit 13a. For example, the neutral point R2 is a connection point between a source of the high-side arm element portion 31a (b2H) and a drain of the low-side arm element portion 31b (b2L). The neutral point R3 of the fourth full-bridge circuit 13b is, for example, a connection point between a high-side arm element portion 31a (b3H) and a low-side arm element portion 31b (b3L) that are connected in series in a first phase among first and second phases of two phases of the fourth full-bridge circuit 13b. For example, the neutral point R3 is a connection point between a source of the high-side arm element portion 31a (b3H) and a drain of the low-side arm element portion 31b (b3L).

The second switch 32 is, for example, a bidirectional switch formed of two switching elements. Each switching element is a transistor such as a MOSFET or an IGBT and is, for example, an N-channel type MOSFET. The second switch 32 includes, for example, two transistors connected reversely in series. For example, the sources of the two transistors are connected to each other, and thereby, the two transistors are connected in series in a direction opposite to each other. The second switch 32 switches conduction and cutoff of a current between the neutral points R2, R3 by ON (conduction)/OFF (cutoff) of the two transistors.

Each transistor may include a rectifier element such as a reflux diode which is connected in parallel between a collector and an emitter in a forward direction toward the collector from the emitter.

The second electric power conversion portion 13 is connected to a β-phase first coil 33 (β1) and a β-phase second coil 34 (β2) of the rotary electric machine 16 described later. The β-phase first coil 33 is connected between neutral points R1, R2 of the third full-bridge circuit 13a. The β-phase second coil 34 (β2) is connected between neutral points R3, R4 of the fourth full-bridge circuit 13b. The neutral point R1 of the third full-bridge circuit 13a is, for example, a connection point between a high-side arm element portion 31a (b1H) and a low-side arm element portion 31b (b1L) that are connected in series in the first phase of the third full-bridge circuit 13a. For example, the neutral point R1 is a connection point between a source of the high-side arm element portion 31a (b1H) and a drain of the low-side arm element portion 31b (b1L). The neutral point R4 of the fourth full-bridge circuit 13b is, for example, a connection point between a high-side arm element portion 31a (b4H) and a low-side arm element portion 31b (b4L) that are connected in series in the second phase of the fourth full-bridge circuit 13b. For example, the neutral point R4 is a connection point between a source of the high-side arm element portion 31a (b4H) and a drain of the low-side arm element portion 31b (b4L).

The second electric power conversion portion 13 includes a third connection-disconnection device 35 connected between one end of the β-phase first coil 33 (β1) and the third full-bridge circuit 13a and a fourth connection-disconnection device 36 connected between one end of the β-phase second coil 34 (β2) and the fourth full-bridge circuit 13b.

Each of the third connection-disconnection device 35 and the fourth connection-disconnection device 36 is, for example, a contactor. The third connection-disconnection device 35 is connected, for example, between the one end of the β-phase first coil 33 (β1) and the neutral point R1 of the first phase of the third full-bridge circuit 13a and switches between ON (conduction) and OFF (cutoff) of the connection between the β-phase first coil 33 (β1) and the neutral point R1. The fourth connection-disconnection device 36 is connected, for example, between the one end of the β-phase second coil 34 (β2) and the neutral point R4 of the second phase of the fourth full-bridge circuit 13b and switches between ON (conduction) and OFF (cutoff) of the connection between the β-phase second coil 34 (β2) and the neutral point R4.

The second electric power conversion portion 13 includes, for example, a capacitor (condenser) 37 connected between the positive electrode and the negative electrode. For example, the capacitor 37 smooths voltage variation generated in accordance with a switching operation between ON (conduction) and OFF (cutoff) of each switching element of the second electric power conversion portion 13.

The second electric power conversion portion 13 includes, for example, a fourth current sensor 38a arranged between the β-phase first coil 33 (β1) and the neutral point R2 and a fifth current sensor 38b arranged between the β-phase second coil 34 (β2) and the neutral point R4.

For example, the fourth current sensor 38a detects a current that flows through the β-phase first coil 33 (β1). The fifth current sensor 38b detects a current that flows through the β-phase second coil 34 (β2).

The second electric power conversion portion 13 includes, for example, a fifth connection-disconnection device 39 that is connected between the AC electric power source connection portion 15 described later and a connection point between the β-phase first coil 33 (β1) and the third connection-disconnection device 35. The fifth connection-disconnection device 39 is, for example, a contactor. The fifth connection-disconnection device 39 switches between ON (conduction) and OFF (cutoff) of the connection between the AC electric power source connection portion 15 and the β-phase first coil 33 (β1).

The DC electric power source connection portion 14 and the AC electric power source connection portion 15 include, for example, a connection device (connector) or the like for DC electric power and for AC electric power of a predetermined standard. The DC electric power source connection portion 14 and the AC electric power source connection portion 15 are connected, for example, to a DC electric power source (external DC electric power source) and an AC electric power source (external AC electric power source) at the outside on the basis of a commercial electric power source or the like connected to an electric power system.

The DC electric power source connection portion 14 is connected, for example, to the negative electrode of the second electric power conversion portion 13 and to a neutral point (that is, a point between the two transistors connected reversely in series) of each of the first switch 22 and the second switch 32.

The AC electric power source connection portion 15 is connected, for example, to each of the first neutral point R1 and the fourth neutral point R4 of the second electric power conversion portion 13 and to the fifth connection-disconnection device 39 and the connection point between the β-phase second coil 34 (β2) and the fourth connection-disconnection device 36.

The rotary electric machine 16 (M) is, for example, a two-phase AC brushless DC motor. The rotary electric machine 16 includes, for example, the α-phase first coil 23 (α1), the α-phase second coil 24 (α2), the β-phase first coil 33 (β1), the β-phase second coil 34 (β2), a rotor 41, and a stator core 42.

The rotor 41 includes a field permanent magnet. Each coil α1, α2, Bβ1, β2 that generates a rotating magnetic field which rotates the rotor 41 is attached to the stator core 42.

The α-phase first coil 23 (α1), the α-phase second coil 24 (α2), the β-phase first coil 33 (β1), and the β-phase second coil 34 (β2) are so-called open-ended coils. Ends of the coils α1, α2, Bβ1, β2 are not connected to each other (that is, the coils α1, α2, Bβ1, β2 are separated from each other) and are drawn out to the outside of the rotary electric machine 16.

The α-phase first coil 23 (α1) and the α-phase second coil 24 (α2) set, for example, a spatial phase difference from each other to be zero and are wound with respect to the different teeth of the stator core 42 in the same direction when seen from an axis line direction along a center axis of the rotary electric machine 16 (M). The α-phase first coil 23 (α1) and the α-phase second coil 24 (α2) are arranged, for example, so as to share part of a slot 43 formed in the stator core 42 and are magnetically coupled to each other in the same polarity.

The β-phase first coil 33 (β1) and the β-phase second coil 34 (β2) set, for example, a spatial phase difference from each other to be zero and are wound with respect to the different teeth of the stator core 42 in the same direction when seen from the axis line direction along the center axis of the rotary electric machine 16 (M). The β-phase first coil 33 (β1) and the β-phase second coil 34 (β2) are arranged, for example, so as to share part of the slot 43 formed in the stator core 42 and are magnetically coupled to each other in the same polarity.

The α-phase first coil 23 (α1), the α-phase second coil 24 (α2), the β-phase first coil 33 (β1), and the β-phase second coil 34 (β2) are arranged such that the α-phase first coil 23 (α1) and the α-phase second coil 24 (α2) do not magnetically interfere with the β-phase first coil 33 (β1) and the β-phase second coil 34 (β2) by setting the spatial phase difference from each other to be 90°.

For example, each coil α1, α2, Bβ1, β2 is attached to the stator core 42 by concentrated winding, distributed winding, or the like, and the coils α1, α2, Bβ1, β2 have the same number of winding as one another.

The rotary electric machine 16 (M) generates rotation power by performing a power running operation using electric power supplied from the first electric power conversion portion 12 and the second electric power conversion portion 13. For example, when the rotary electric machine 16 (M) is connected to a wheel of the vehicle, the rotary electric machine 16 (M) generates a travel drive force by the electric power supplied from the first electric power conversion portion 12 and the second electric power conversion portion 13. The rotary electric machine 16 (M) may generate electric power by performing a regeneration operation using rotation power input from the wheel side of the vehicle. For example, when the rotary electric machine 16 (M) is connected to the internal combustion engine of the vehicle, the rotary electric machine 16 (M) may generate electric power using the power of the internal combustion engine.

The gate drive unit 17 switches between ON (conduction) and OFF (cutoff) of each connection-disconnection device 25, 26, 35, 36, 39 and each switching element of the first electric power conversion portion 12 and the second electric power conversion portion 13 on the basis of a control signal received from the electronic control unit 18. For example, the gate drive unit 17 switches between ON (conduction) and OFF (cutoff) of each switching element of each full-bridge circuit 12a, 12b, 13a, 13b by outputting a gate signal generated by amplification, level shift, and the like of the control signal.

The electronic control unit 18 integrally controls an operation of each of the electric power control unit 10a and the rotary electric machine 16 (M). For example, the electronic control unit 18 is a software function unit that functions by a predetermined program being executed by a processor such as a CPU (Central Processing Unit). The software function unit is an ECU (Electronic Control Unit) that includes the processor such as a CPU, a ROM (Read Only Memory) that stores the program, a RAM (Random Access Memory) that temporarily stores data, and an electronic circuit such as a timer. At least part of the electronic control unit 18 may be an integrated circuit such as a LSI (Large Scale Integration).

The electronic control unit 18 generates a control signal indicating a timing when each connection-disconnection device 25, 26, 35, 36, 39 and each switching element of the first electric power conversion portion 12 and the second electric power conversion portion 13 are driven to ON (conduction) and OFF (cutoff). The electronic control unit 18 inputs the generated control signal to the gate drive unit 17.

### (Control Operation of Electric Apparatus)

The electronic control unit 18 sets the first connection-disconnection device 25 and the second connection-disconnection device 26 to be in an ON (conduction) state in the case of the power running operation or the regeneration operation of the rotary electric machine 16 (M). The electronic control unit 18 switches between a state in which the α-phase coils α1, α2 are connected in series and the β-phase coils Bβ1, β2 are connected in series, and a state in which the α-phase coils α1, α2 are connected in parallel and the the β-phase coils Bβ1, β2 are connected in parallel by the switching between ON (conduction) and OFF (cutoff) of the first switch 22 and the second switch 32.

The electronic control unit 18 performs, for example, a feedback control or the like of a current in which the current detection value of the rotary electric machine 16 (M) and the current target value in accordance with the torque command value of the rotary electric machine 16 (M) are used and generates a control signal that commands the driving of each switching element of the first electric power conversion portion 12 and the second electric power conversion portion 13.

At the time of DC charging, that is, when the electric power storage device 11 is charged by the external DC electric power source connected to the DC electric power source connection portion 14, the electronic control unit 18 sets the first connection-disconnection device 25 and the second connection-disconnection device 26 to be in an ON (conduction) state. The electronic control unit 18 causes each of the combination of the α-phase coils α1, α2 and the first electric power conversion portion 12 and the combination of the β-phase coils Bβ1, β2 and the second electric power conversion portion 13 to function as a non-insulation type DC-DC converter performing a voltage increase operation by a so-called chopper control, for example, with respect to the external DC electric power source having a lower voltage than that of the electric power storage device 11.

At the time of AC charging, that is, when the electric power storage device 11 is charged by the external AC electric power source connected to the AC electric power source connection portion 15, the electronic control unit 18 sets the first connection-disconnection device 25 and the second connection-disconnection device 26 to be in an OFF (cutoff) state for insulation.

The electronic control unit 18 sets, for example, the α-phase first coil 23 (α1) and the α-phase second coil 24 (α2) that are magnetically coupled to each other in the same polarity to be a coil of a DC conversion phase (a phase) used for conversion between DC electric power. The electronic control unit 18 causes, for example, the combination of the α-phase coils α1, α2 and the first electric power conversion portion 12 to function as a DAB (Dual Active Bridge) type DC-DC converter which is an insulation-type bidirectional (voltage increase and voltage decrease) converter.

The electronic control unit 18 sets, for example, the β-phase first coil 33 (β1) and the β-phase second coil 34 (β2) that are magnetically coupled to each other in the same polarity to be a coil of an AC input phase (β phase) connected to the external AC electric power source. The electronic control unit 18 causes, for example, the combination of the β-phase coils Bβ1, β2 and the second electric power conversion portion 13 to function as a so-called full-bridgeless type (or bridgeless and totem pole type) power factor correction (PFC) circuit which converts AC electric power into DC electric power. The so-called bridgeless PFC is a PFC that does not include a bridge rectifier by a plurality of diodes which are connected by bridge connection. The so-called totem pole PFC is a PFC that includes a pair of switching elements of the same conductivity type which are connected (totem pole connection) in series in the same direction. The electronic control unit 18 performs the power factor correction of an input voltage Vac and an input current lac while performing rectification of AC electric power received from the external AC electric power source into DC electric power and increasing the voltage, for example, by controlling the switching of each switching element in each full-bridge circuit 13a, 13b of the second electric power conversion portion 13.

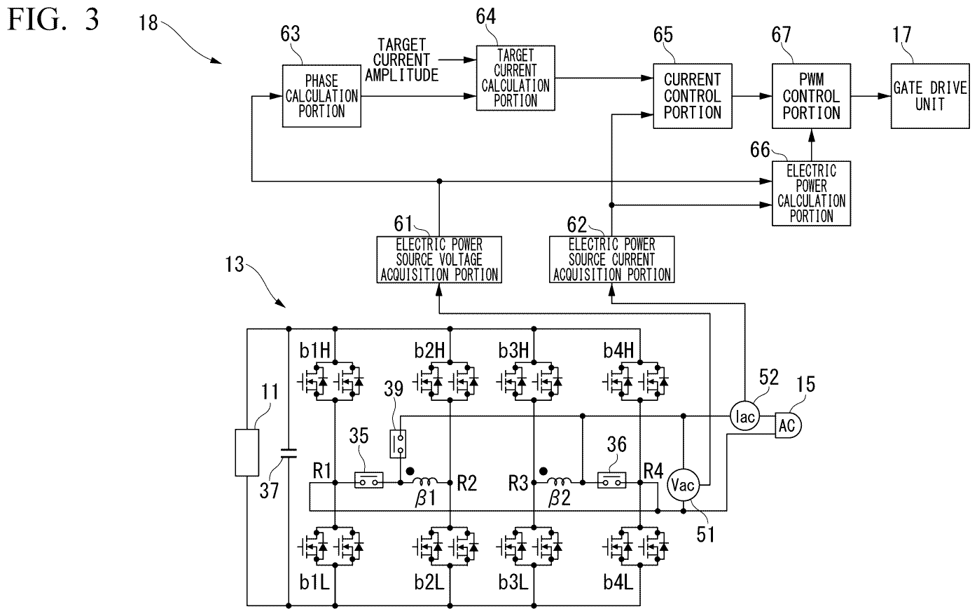

FIG. 3 is a block diagram showing a functional configuration of the electronic control unit 18 at the time of AC charging in the electric apparatus 10 of the embodiment.

As shown in FIG. 3, the second electric power conversion portion 13 includes, for example, an input voltage sensor 51 that detects an input voltage Vac of the external AC electric power source and an input current sensor 52 that detects an input current Iac of the external AC electric power source.

The electronic control unit 18 includes, for example, an electric power source voltage acquisition portion 61, an electric power source current acquisition portion 62, a phase calculation portion 63, a target current calculation portion 64, a current control portion 65, an electric power calculation portion 66, and a PWM control portion 67.

The electric power source voltage acquisition portion 61 outputs, for example, the input voltage Vac acquired from the input voltage sensor 51.

The electric power source current acquisition portion 62 outputs, for example, the input current Iac acquired from the input current sensor 52.

The phase calculation portion 63 calculates, for example, a phase of the input voltage Vac that is output from the electric power source voltage acquisition portion 61.

The target current calculation portion 64 calculates, for example, a target current synchronized with the input voltage Vac on the basis of a target current amplitude with respect to the input current Iac and the phase of the input voltage Vac that is output from the phase calculation portion 63.

The current control portion 65 outputs a duty ratio of a voltage command, for example, by a PI (proportional-integral) control or the like based on a current deviation obtained by subtraction between the target current that is output from the target current calculation portion 64 and the input current Iac that is output from the electric power source current acquisition portion 62. The duty ratio of the voltage command defines a ratio of an on-time of the switching elements (that is, high-side arm and low-side arm switching elements of each phase) that form a pair in each phase of each full-bridge circuit 13a, 13b of the second electric power conversion portion 13 to a switching cycle.

The electric power calculation portion 66 outputs, for example, electric power of the electric power source obtained by multiplication of the input voltage Vac that is output from the electric power source voltage acquisition portion 61 and the input current Iac that is output from the electric power source current acquisition portion 62.

The PWM control portion 67 generates a control signal indicating a timing when each switching element of each full-bridge circuit 13a, 13b of the second electric power conversion portion 13 is driven between ON (conduction) and OFF (cutoff), for example, by a pulse width modulation operation based on the duty ratio of the voltage command that is output from the current control portion 65. The PWM control portion 67 switches between and sets a switching pattern of a series mode shown in Table 1 described below and a switching pattern of a parallel mode shown in Table 2 described below, for example, in accordance with the electric power of the electric power source that is output from the electric power calculation portion 66.

TABLE 1

| | ELEMENT PORTION | | | | | | | |
|---|---|---|---|---|---|---|---|---|
| MODE | b1H | b1L | b2H | b2L | b3H | b3L | b4H | b4L |
| FIRST MODE | OFF | OFF | ON | OFF | ON | OFF | OFF | OFF |
| (CHARGING) | | | | | | | | |
| SECOND MODE | OFF | OFF | OFF | ON | ON | OFF | OFF | OFF |
| (DISCHARGING) | | | | | | | | |
| THIRD MODE | OFF | OFF | OFF | ON | OFF | ON | OFF | OFF |
| (DISCHARGING) | | | | | | | | |
| FOURTH MODE | OFF | OFF | OFF | ON | OFF | ON | OFF | OFF |
| (CHARGING) | | | | | | | | |

TABLE 2

| | ELEMENT PORTION | | | | | | | |
|---|---|---|---|---|---|---|---|---|
| MODE | b1H | b1L | b2H | b2L | b3H | b3L | b4H | b4L |
| FIRST MODE | ON | OFF | ON | OFF | OFF | ON | OFF | ON |
| (CHARGING) | | | | | | | | |
| SECOND MODE | ON | OFF | OFF | ON | ON | OFF | OFF | ON |
| (DISCHARGING) | | | | | | | | |
| THIRD MODE | OFF | ON | ON | OFF | OFF | ON | ON | OFF |
| (DISCHARGING) | | | | | | | | |
| FOURTH MODE | OFF | ON | OFF | ON | ON | OFF | ON | OFF |
| (CHARGING) | | | | | | | | |

In the switching pattern shown in each of Table 1 and Table 2 described above, the first mode and the fourth mode are a mode in which the β-phase first coil 33 (β1) and the β-phase second coil 34 (β2) are charged, and the second mode and the third mode are a mode in which the β-phase coils 33 (β1), 34 (β2) are discharged.

In each of Table 1 and Table 2 described above, for example, in accordance with the decrease of a duty (ON ratio) of high-side arm element portions b2H, b3H of a second leg and a third leg in the second electric power conversion portion 13 toward 0.5, the first mode and the fourth mode in which the β-phase coils 33 (β1), 34 (β2) are charged are increased, and the third mode in which the β-phase coils 33 (β1), 34 (β2) are discharged is reduced. For example, when the duty (ON ratio) of the high-side arm element portions b2H, b3H of the second leg and the third leg is 0.5, there are only the first mode and the fourth mode in which the β-phase coils 33 (β1), 34 (β2) are charged. For example, in accordance with the decrease of the duty (ON ratio) of the high-side arm element portions b2H, b3H of the second leg and the third leg from 0.5, the first mode and the fourth mode in which the β-phase coils 33 (β1), 34 (β2) are charged are reduced, and the second mode in which the β-phase coils 33 (β1), 34 (β2) are discharged is increased.

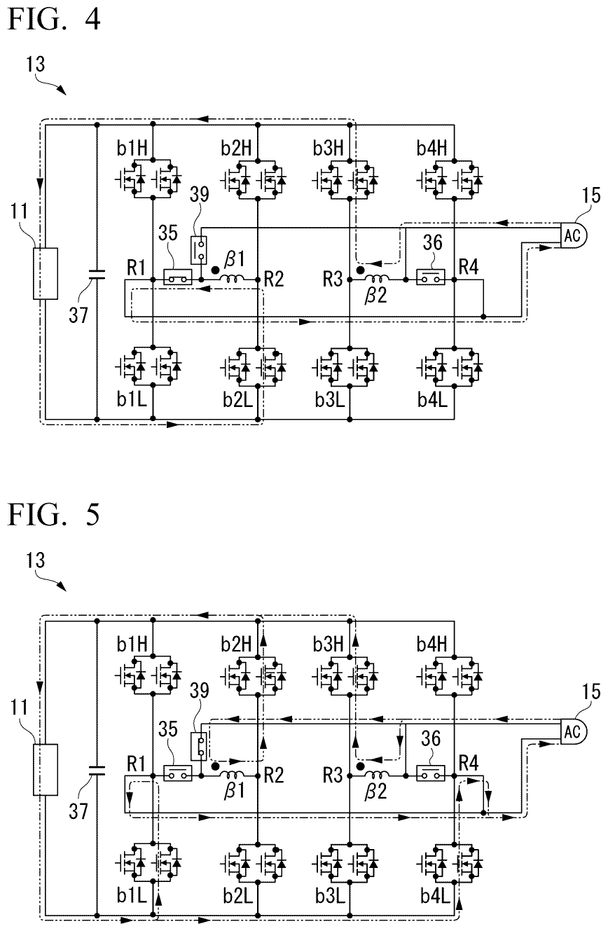

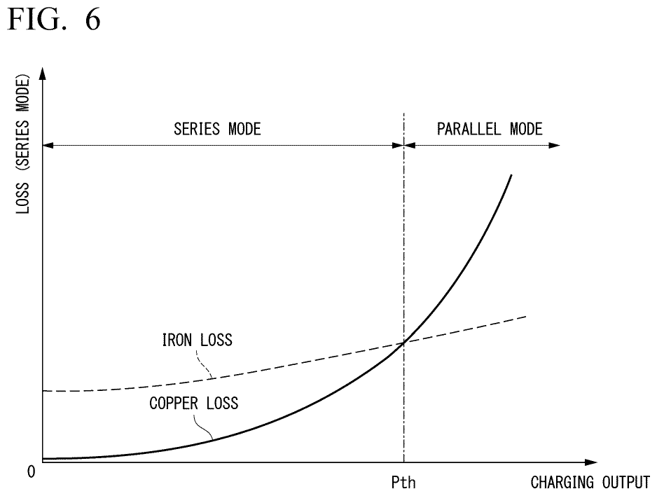

FIG. 4 is a circuit diagram showing an example of the flow of a current in a series mode at the time of AC charging in the electric apparatus 10 of the embodiment. FIG. 5 is a circuit diagram showing an example of the flow of a current in a parallel mode at the time of AC charging in the electric apparatus 10 of the embodiment. FIG. 6 is a view showing an example of a correspondence relationship between a charging output (electric power of the electric power source of the external AC electric power source) and the loss of the series mode at the time of AC charging in the electric apparatus 10 of the embodiment.

For example, when the electric power (electric power of the electric power source) of the external AC electric power source at the time of AC charging of the electric apparatus 10 is less than predetermined electric power Pth, the electronic control unit 18 sets the series mode as shown in Table 1 described above and FIG. 4. The series mode is a mode in which a relatively large inductance is obtained by connecting the β-phase first coil 33 (β1) and the β-phase second coil 34 (β2) in series.

For example, when the electric power (electric power of the electric power source) of the external AC electric power source at the time of AC charging of the electric apparatus 10 is equal to or more than the predetermined electric power Pth, the electronic control unit 18 sets the parallel mode as shown in Table 2 described above and FIG. 5. The parallel mode is a mode in which a relatively small inductance is obtained by connecting the β-phase first coil 33 (β1) and the β-phase second coil 34 (β2) in parallel.

The predetermined electric power Pth is, for example, a threshold electric power in which the copper loss of the rotary electric machine 16 in the series mode becomes larger than the iron loss or the like as shown in FIG. 6.

As shown in FIG. 4, in the case of the series mode, the electronic control unit 18 sets the third connection-disconnection device 35 to be in an ON (conduction) state and sets the fourth connection-disconnection device 36 and the fifth connection-disconnection device 39 to be in an OFF (cutoff) state. In the case of the series mode, currents in a so-called identical direction to each other flow from the AC electric power source connection portion 15 to the coils Bβ1, β2. The currents that flow through the β-phase first coil 33 (β1) and the β-phase second coil 34 (β2) are in-phase currents of which magnetic fluxes are not canceled each other.

As shown in FIG. 5, in the case of the parallel mode, the electronic control unit 18 sets the third connection-disconnection device 35 and the fourth connection-disconnection device 36 to be in an OFF (cutoff) state and sets the fifth connection-disconnection device 39 to be in an ON (conduction) state. In the case of the parallel mode, currents in a so-called opposite direction to each other flow from the AC electric power source connection portion 15 to the coils Bβ1, β2. The currents that flow through the β-phase first coil 33 (β1) and the β-phase second coil 34 (β2) are reverse-phase currents of which magnetic fluxes cancel each other out. The magnetic fluxes of the β-phase coils 33 (β1), 34 (β2) cancel each other out, and thereby, the inductance of each β-phase coil 33 (β1), 34 (β2) is a leakage inductance due to the leakage magnetic flux.

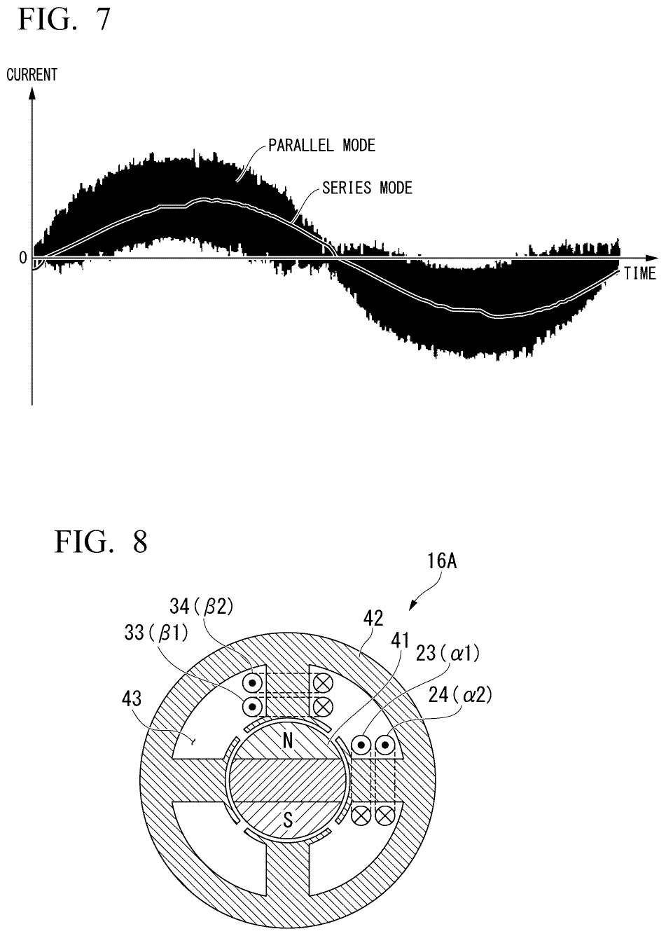

FIG. 7 is a view showing an example of a simulation of the change of a current in each of the series mode and the parallel mode at the time of AC charging in the electric apparatus 10 of the embodiment.

As shown in FIG. 7, in the case of the series mode, by supplying the in-phase current to each β-phase coil 33 (β1), 34 (β2), the inductance becomes relatively large compared to the parallel mode, and ripple and distortion of the current or the like are reduced. In the case of the parallel mode, by supplying the current such that magnetic fluxes of the β-phase coils 33 (β1), 34 (β2) cancel each other out, the inductance becomes relatively small compared to the series mode, and ripple and distortion of the current or the like are increased.

When the electric power (electric power of the electric power source) of the external AC electric power source is less than the predetermined electric power Pth, the electronic control unit 18 selects the series mode and thereby improves charging efficiency while preventing the ripple and distortion of the current or the like. When the electric power (electric power of the electric power source) of the external AC electric power source is equal to or more than the predetermined electric power Pth, by selecting the parallel mode, the electronic control unit 18 prevents an increase of the loss such as copper loss compared to the series mode and increases a voltage increase ratio by a relatively small leakage inductance.

As described above, according to the electric apparatus 10 of the embodiment, in a low output region in which the decrease of the efficiency due to ripple and distortion of the current that flows through each β-phase coil 33 (β1), 34 (β2) or the like is large, by the series mode, it is possible to increase the inductance and prevent the ripple and distortion of the current or the like. In a high output region in which copper loss and iron loss are increased in accordance with the increase of the current in the series mode, by switching the mode to the parallel mode, it is possible to decrease the inductance and reduce the loss.

It is possible to easily switch between the series connection and the parallel connection by including the fifth connection-disconnection device 39, and it is possible to prevent an increase of the number of components. Each β-phase coil 33 (β1), 34 (β2) is an open-ended coil connected to each full-bridge circuit 13a, 13b, and thereby, it is possible to increase a voltage applied to each β-phase coil 33 (β1), 34 (β2) relative to a charging voltage and increase a charging speed, for example, as compared with the case where each β-phase coil 33 (β1), 34 (β2) is not an open-ended coil or the like.

In the case of the parallel mode, by supplying electric power to the β-phase coils 33 (β1), 34 (β2) that are arranged in the same slot 43 such that the magnetic fluxes cancel each other out, it is possible to prevent torque generation of the rotary electric machine 16 (M), and it is possible to increase a voltage increase ratio by a relatively small leakage inductance.

### Modification Example

Hereinafter, modification examples of the embodiment will be described. The same parts as those of the above-described embodiment are denoted by the same reference numerals, and descriptions thereof are omitted or simplified.

The above embodiment is described using an example in which each of the α-phase first coil 23 (α1), the α-phase second coil 24 (α2), the β-phase first coil 33 (β1), and the β-phase second coil 34 (β2) is wound around the different teeth of the stator core 42; however, the embodiment is not limited thereto.

FIG. 8 is a configuration view of a rotary electric machine 16A of the electric apparatus 10 in a modification example of the embodiment.

As shown in FIG. 8, the α-phase first coil 23 (α1) and the α-phase second coil 24 (α2) may be wound around the same teeth of the stator core 42, and the β-phase first coil 33 (β1) and the β-phase second coil 34 (β2) may be wound around the same teeth of the stator core 42.

The above embodiment is described using an example in which the second electric power conversion portion 13 includes the fifth connection-disconnection device 39; however, the embodiment is not limited thereto.

For example, instead of the fifth connection-disconnection device 39, the second electric power conversion portion 13 may include a sixth connection-disconnection device connected between the AC electric power source connection portion 15 and a connection point between the β-phase second coil 34 (β2) and the fourth connection-disconnection device 36. The electronic control unit 18 may switch between the series mode and the parallel mode by the ON and OFF of the third connection-disconnection device 35, the fourth connection-disconnection device 36, and the sixth connection-disconnection device.

The above embodiment is described using an example in which the β-phase first coil 33 (β1) and the β-phase second coil 34 (β2) are magnetically coupled to each other in the same polarity; however, the embodiment is not limited thereto. The β-phase first coil 33 (β1) and the β-phase second coil 34 (β2) may be magnetically coupled to each other in an opposite polarity. In this case, for example, a connection-disconnection device connected between one end of the β-phase first coil 33 (β1) and the neutral point R2 of the second phase of the third full-bridge circuit 13a or a connection-disconnection device connected between one end of the β-phase second coil 34 (β2) and the neutral point R3 of the first phase of the fourth full-bridge circuit 13b may be provided. In short, in the state of the parallel mode at the time of AC charging, in accordance with the polarity of the magnetic coupling of the β-phase first coil 33 (β1) and the β-phase second coil 34 (β2), a current in a flow direction in which the magnetic fluxes cancel each other out may be supplied.

The above embodiment is described using an example in which, as a parallel pattern, the DC electric power source connection portion 14 is connected to the negative electrode of the second electric power conversion portion 13 and to the neutral point (that is, between the two transistors connected reversely in series) of each of the first switch 22 and the second switch 32; however, the embodiment is not limited thereto. For example, as a series pattern, the DC electric power source connection portion 14 may be connected to the negative electrode of the second electric power conversion portion 13 and to the neutral point Q4 of the first electric power conversion portion 12 and the neutral point R4 of the second electric power conversion portion 13. For example, as another parallel pattern, the DC electric power source connection portion 14 may be connected to the negative electrode of the second electric power conversion portion 13 and to the neutral points Q2, Q4 of the first electric power conversion portion 12 and the neutral points R2, R4 of the second electric power conversion portion 13.

The embodiments of the present invention have been presented as examples and are not intended to limit the scope of the invention. The embodiments can be implemented in a variety of other modes, and various omissions, substitutions, and modifications can be made without departing from the scope of the invention. The embodiments and modifications thereof are included within the scope and the gist of the invention and are also included within the scope of the invention described in the appended claims and equivalents thereof.

What is claimed is:

1. An electric apparatus comprising:
an electric power storage device;
a rotary electric machine that includes a first coil and a second coil;
an electric power control unit that is connected to the electric power storage device and the rotary electric machine and controls electric power transfer of each of the electric power storage device and the rotary electric machine; and
an electric power source connection member that connects the electric power control unit to an external electric power source,
wherein the electric power control unit comprises:
a first full-bridge circuit that is connected to both ends of the first coil;
a second full-bridge circuit that is connected to both ends of the second coil;
a first connection-disconnection device that is connected between one end of the first coil and the first full-bridge circuit; and
a second connection-disconnection device that is connected between one end of the second coil and the second full-bridge circuit,
the electric power source connection member is connected to both ends of each of the first connection-disconnection device and the second connection-disconnection device,
the electric power control unit connects the first coil and the second coil in series when electric power of the external electric power source is less than predetermined electric power, and
the electric power control unit connects the first coil and the second coil in parallel when the electric power of the external electric power source is equal to or more than the predetermined electric power.

2. The electric apparatus according to claim 1, comprising:
a third connection-disconnection device that is connected between the electric power source connection member and the first connection-disconnection device or the second connection-disconnection device,
wherein the third connection-disconnection device is set to be in a disconnection state when the electric power of the external electric power source is less than the predetermined electric power, and
the third connection-disconnection device is set to be in a connection state when the electric power of the external electric power source is equal to or more than the predetermined electric power.

3. The electric apparatus according to claim 1,
wherein the rotary electric machine comprises a stator core on which a slot shared by the first coil and the second coil is formed, and
when the first coil and the second coil are connected in parallel, the electric power control unit sets a flow direction in the first coil and the second coil of a current supplied from the external electric power source such that magnetic fluxes of the first coil and the second coil that are magnetically coupled cancel each other out.

4. The electric apparatus according to claim 2,
wherein the rotary electric machine comprises a stator core on which a slot shared by the first coil and the second coil is formed, and
when the first coil and the second coil are connected in parallel, the electric power control unit sets a flow direction in the first coil and the second coil of a current supplied from the external electric power source such that magnetic fluxes of the first coil and the second coil that are magnetically coupled cancel each other out.
